(19) United States
(12) Patent Application Publication
(10) Pub. No.: US 2008/0046172 A1
(43) Pub. Date: Feb. 21, 2008

(54) Method and apparatus for communicating a graphic image to a mobile platform via broadcast services

(75) Inventors: Michael B. Ames, Lake Orion, MI (US); Timothy J. Talty, Beverly Hills, MI (US); Cem U. Saraydar, Royal Oak, MI (US); Andrew J. MacDonald, Grosse Pointe Park, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/829,282

(22) Filed: Jul. 27, 2007

Related U.S. Application Data
(60) Provisional application No. 60/821,439, filed on Aug. 4, 2006.

(51) Int. Cl. G01C 21/30

(52) U.S. Cl. 701/208

(57) ABSTRACT

A mobile platform is equipped with a broadcast signal receiver operative to receive a broadcast message, an electronic memory storage device, a processor, and, a human-machine interface comprising a visual display screen. A first message is broadcast from a communications source and received at the mobile platform via the broadcast signal receiver. The first message includes a graphic image which is cached in the electronic memory storage device and selectively displayed with the visual display screen of the human-machine interface.

### CROSS-REFERENCE TO RELATED APPLICATIONS

This application claims priority from U.S. Provisional Application No. 60/821,439, filed on Aug. 4, 2006, which is incorporated herein by reference.

### TECHNICAL FIELD

This disclosure pertains generally to mobile platforms and more specifically to wireless communications thereto.

### BACKGROUND OF THE INVENTION

The statements in this section merely provide background information related to the present disclosure and may not constitute prior art.

There is a growing application of wireless communication services for mobile platforms, e.g., motor vehicles, personal navigation devices, or other hand-held devices such as cellular phones, to provide features related to navigation and roadside assistance. Known on-board navigation systems typically use an on-board memory device, e.g., a CD, DVD, hard drive or flash memory, which contains electronic data comprising map information which is used by a navigation system to provide route information based upon current location and a desired destination. Such on-board map databases contain map information describing the road network generally in terms of elements, such as nodes, segments and regions. Also included in the map information are features, such as street address, travel restrictions, geometrical description, road class and others which reference those elements. This map information may be used by the navigation application to render a viewable image on a display device such as a liquid crystal display (LCD) and permit calculation of routes based upon pre-determined attributes or attributes selected by the user. It is known to update navigation maps that are stored on a computer in a hard drive or other device using wireless or wired techniques. Known systems use a navigation/mapping software application at the navigation device to calculate map presentation and determine optimal routing. Such methods of storing and updating map information are for either a completely new set of map data or for small incremental updates in a format that is optimized for use by the existing mapping/navigation application software in the device. Such methods require that the received “map information” be in a format that is usable by the device's navigation application. Known “map information” developed for navigation devices is created, compressed and compiled by individual device vendors into a proprietary format for a specific navigation application.

Known communications systems utilized with mobile devices comprise point-to-point communications, e.g., cellular systems, which are known to operate at a low frequency bandwidth and are relatively costly. Other communications systems comprise satellite radio systems, which use geostationary satellites to communicate to vehicles, homes and other listening environments with multiple channels of music, news and audio entertainment, and known to operate at low frequency bandwidth, with a national distribution.

Local over-air television broadcasters are converting to a digital television format such as the Advanced Television System Committee (‘ATSC’) standard, which has a data bandwidth of 19 Mbps. High definition television (HDTV) typically utilizes about 9 to 12 Mbps. This means that there is broadcast communications bandwidth available for the delivery of additional content.

### SUMMARY OF THE INVENTION

A method for communicating a graphic image to a mobile platform, includes equipping the mobile platform with a broadcast signal receiver device to receive a broadcast message. The mobile platform is further equipped with an electronic memory storage device, a processor, and a human-machine interface including a visual display screen. A first message broadcast from the communications source within a broadcast signal is received at the mobile platform. The first message includes the graphic image which is cached in the electronic memory storage device and selectively displayed with the visual display screen of the human-machine interface.

### BRIEF DESCRIPTION OF THE DRAWINGS

One or more embodiments will now be described, by way of example, with reference to the accompanying drawings, in which:

FIGS. 1-4 are schematic system diagrams;

FIGS. 5-9 are schematic diagrams of map images; and,

FIG. 10 is an algorithmic flowchart.

### DETAILED DESCRIPTION OF A PREFERRED EMBODIMENT

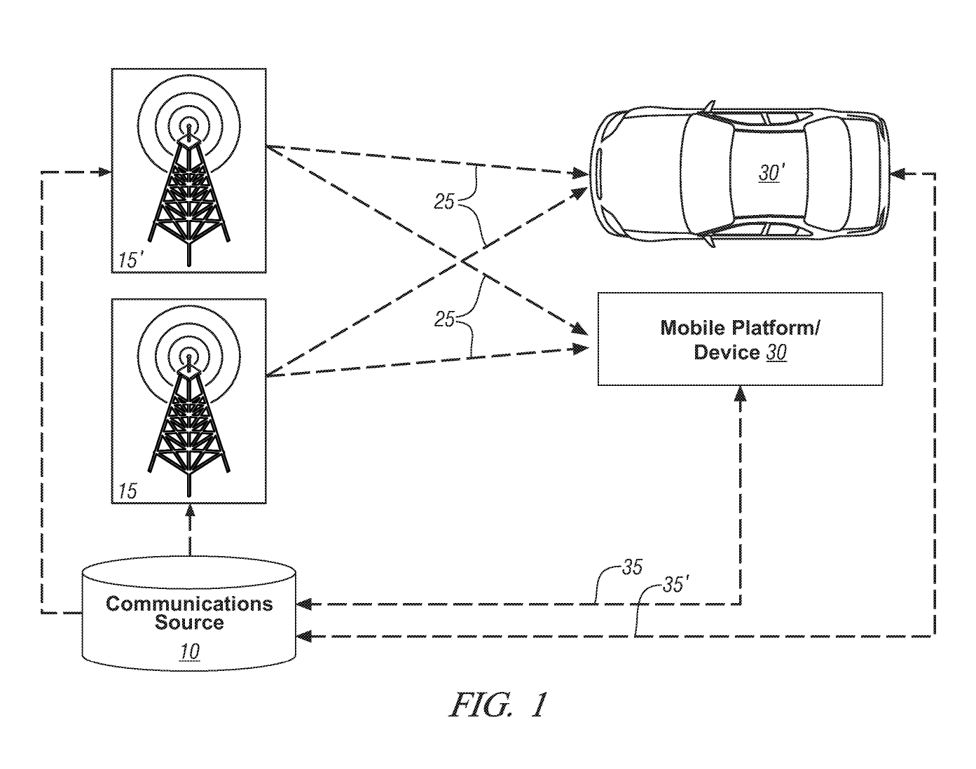

Referring now to the drawings, wherein the showings are for the purpose of illustrating embodiments only and not for the purpose of limiting the same, FIG. 1 depicts a communications system which has been constructed in accordance with an exemplary embodiment. The communications system described herein is for communicating a signal between a communications source 10 and a mobile platform, including communicating from one or more broadcasters to mobile platforms, generally designated as 30 or 30′, as described hereinafter. Each mobile platform is equipped with a wireless interface device (‘WID’) 310 comprising a transceiver. The WID 310 comprises a broadcast message receiver device operative to receive and interpret a broadcast signal originating from the communications source, and a two-way wireless communications device operative to effect two-way wireless communications between the mobile platform(s) 30, 30′ and the communications source 10. The broadcast signal, generally designated as 25, includes overall content transmitted from the communications source 10 via one or more broadcast transmitter(s) 15, 15′. The broadcast signal 25 includes publicly accessible content and a first message readable by the WID 310, at the mobile platform(s) 30, 30′. A first message is formed, comprising a plurality of electronic data files including graphic images such as bitmapped images generated in compressed data formats of map images of a predetermined geographic area. The first message is received at the mobile platform and the graphic image is interpreted therefrom. The graphic image is cached in the electronic memory storage device, and selectively displayed with the visual display screen of the human-machine interface. This is now described in detail.

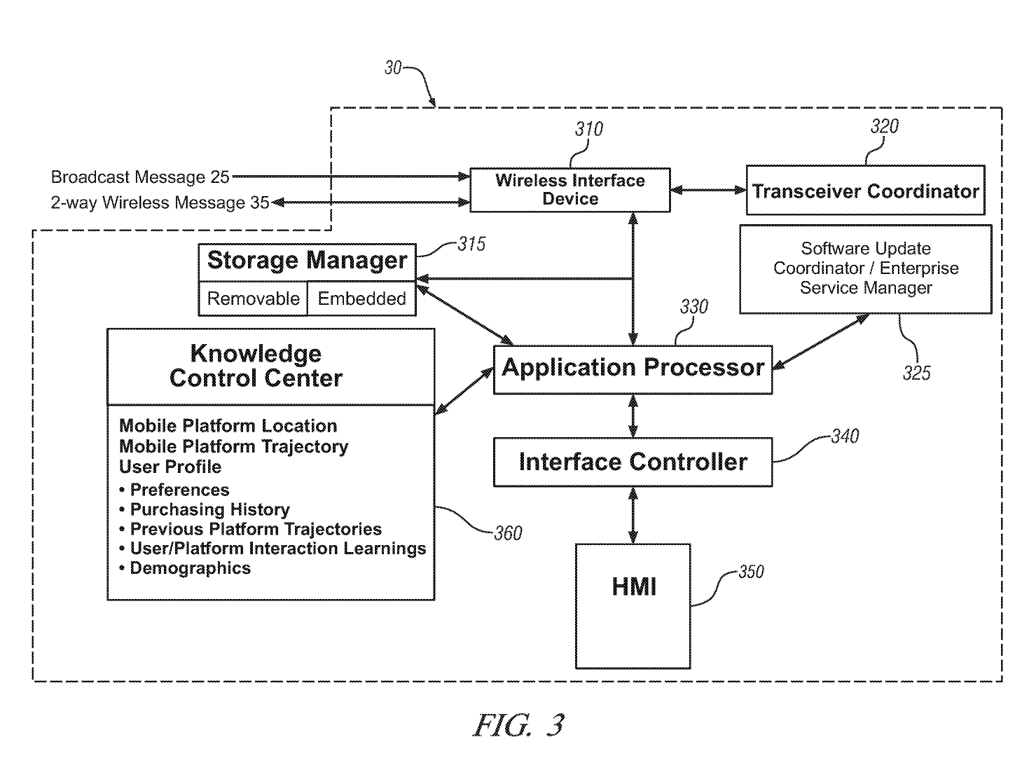

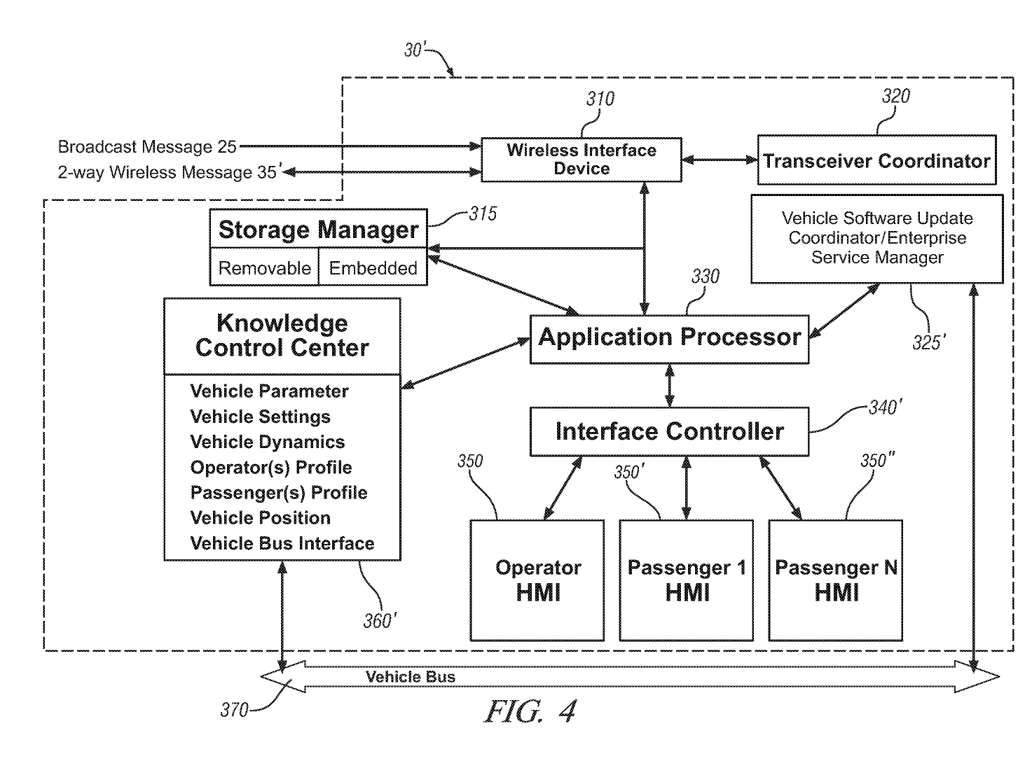

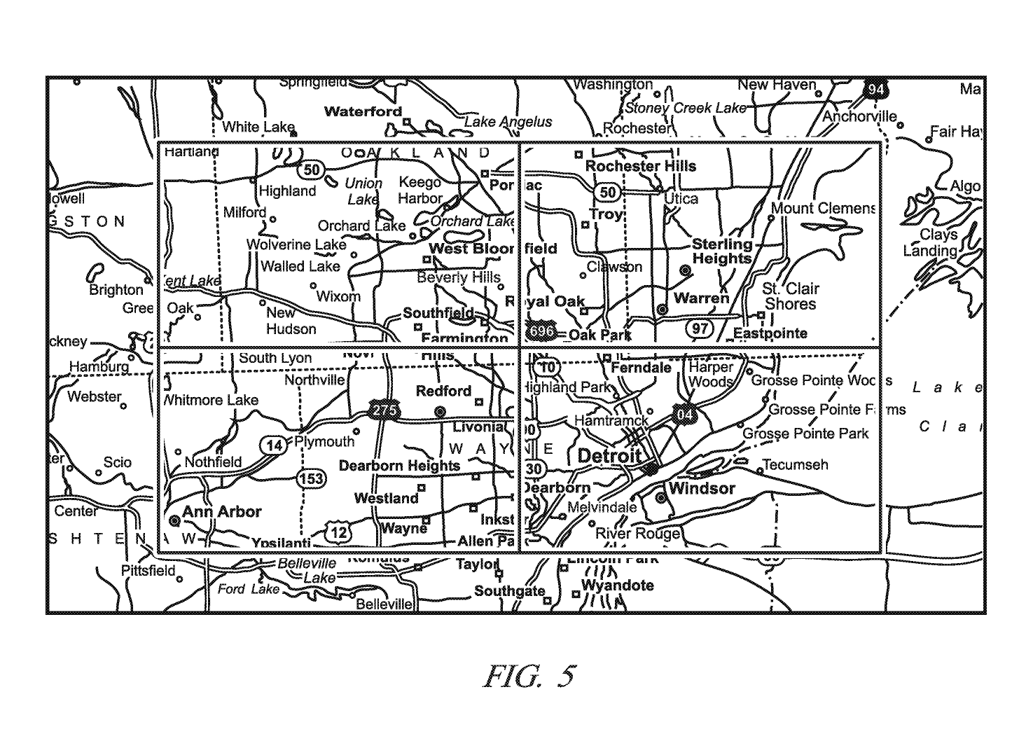

The communications source 10 is signally linked to the broadcast transmitters 15, 15′. Each broadcast transmitter 15, 15′ comprises an electronic device operative to generate and propagate an electromagnetic signal, i.e., the broadcast signal 25 sent from the communications source 10, over airwaves. Individual users are able to access the broadcast signal 25 using a digital television, radio, or other device. The design and operation of a broadcast transmitter is generally known to one skilled in the art. The electromagnetic broadcast signal 25 is received by one or more mobile platforms 30, 30′ each having a communications transceiver. The broadcast signal preferably includes the first message which is formed at the communications source, and described hereinafter with reference to FIGS. 5-9. The first message is opportunistically broadcasted from the communications source, and received and interpreted at the mobile platform by way of the broadcast message receiver portion of the transceiver. A second message is formed and wirelessly communicated between the communications source and the mobile platform by way of the two-way wireless communication device of the transceiver and an enterprise service provider 240 at the communication source. The mobile platforms comprise motor vehicles and other mobile platforms including hand-held devices, described hereinafter with reference to FIGS. 3 and 4.

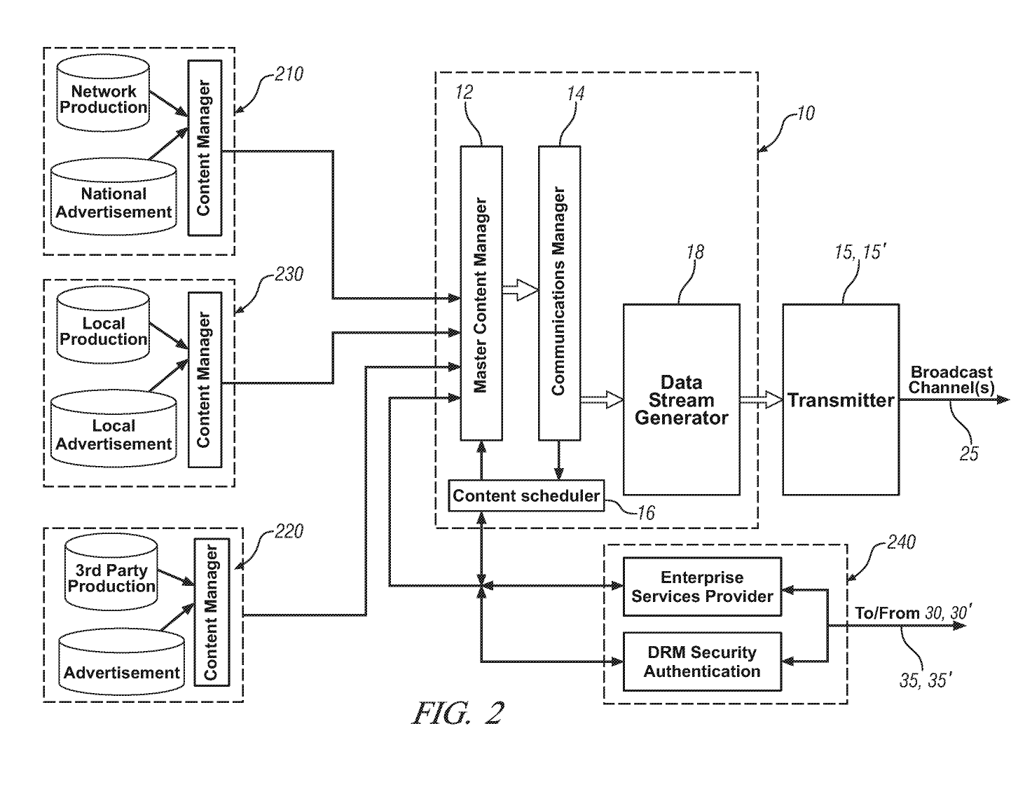

Referring now to FIG. 2, there is depicted a general flow of information through the communications source 10, in accordance with an exemplary embodiment, by which a broadcast signal is formed. The communications source depicted comprises a local television broadcasting station, although other communications sources may be used, e.g., HD radio broadcasting stations. Content providers may comprise a network provider 210, one or more third-party providers 220, and a local provider 230, each of which combines production content intended for viewing on a television with advertising through a respective content manager. The outputs of the content providers are input to a master content manager 12 of the communications source 10. Additionally, with respect to the communications source 10, there is communication to and from an enterprise services provider 240, which in turn is operative to communicate to and from mobile platforms 30, 30′ via a wireless connection. The enterprise services provider 240 may also generate and provide content to mobile platforms 30, 30′. The network provider 210 generates productions having national advertising, in accordance with licensing agreements and requirements with the local broadcaster. The local provider 230 generates productions having local advertising. The third party providers 220 generate productions having national and/or local advertising. The enterprise services provider 240 generates specific message content which is security-authenticated, including, e.g., information obtained from the Internet, comprising the first message.

The communications source 10 comprises the master content manager 12, a communications manager 14, a content scheduler 16, and a datastream generator 18. The communications source 10 is operative to take outputs from the content and enterprise services providers 210, 220, 230, and 240 (hereinafter ‘content providers’) and form an overall message which becomes the broadcast signal 25. The message is communicated through the datastream generator 18 to generate a datastream, which is communicated to the broadcast transmitter(s) 15, 15′ for broadcasting over one or more broadcast channels as the broadcast signal 25. This includes broadcasting the broadcast signal 25 to communication transceivers of mobile platforms 30, 30′ that are in signal range of the broadcast transmitter(s) 15, 15′. The master content manager 12 is operative to ensure all the content of the message is of correct format, i.e., in a format that is in compliance with applicable broadcast standards, e.g., ATSC standards, DVB standards, or another recognized broadcasting standard. The master content manager 12 joins and merges content from the various content providers, including the enterprise services provider. The content scheduler 16 monitors the communications manager 14 and receives input from the enterprise service provider 240, and performs delivery timing scheduling and prioritizes content delivery over the specific broadcast channel. The master content manager 12 assembles the content provided by the content providers and, with input from the content scheduler 16, assigns a content delivery schedule. The assembled content, i.e., the overall message, is sent to the communications manager 14 with the content delivery schedule. The communications manager 14 assigns a specific communication channel for utilization based upon the delivery schedule and communication channel parameters, including parameters such as available bandwidth and channel conditions. The communications transceiver of the mobile platform 30 includes two-way communication channels to enable the mobile platform to initiate and/or reply to the signal delivered thereto. For example, if the mobile platform has determined some of the content of the first message has expired, e.g., weather information, the mobile platform may initiate a request via one of the available two-way channels to the enterprise service provider 240 and the content scheduler 16, which then acts to obtain and send updated information via one of the available broadcast channels. Further, the communication manager can inform the content scheduler of user information obtained via the two-way communication channels.

The communications manager 14 manages the broadcast channel by opportunistically assigning communication channel(s) resources, generating a compliant datastream through the datastream generator 18 that is sent to broadcast transmitter(s) 15, 15′ for transmitting, and when required, verifies delivery of the first message. Thus, the first message is opportunistically broadcasted by incorporation into a high-throughput digital broadcast datastream.

Other functions of the communications manager 14 include enabling security protocols for applications requiring security and encryption, and informing the content scheduler of channel conditions. The content scheduler 16 performs delivery timing scheduling and prioritizes content delivery over the specific broadcast channel. Each of the communication channels comprises a one-way broadcast communication channel or two-way wireless communication channel between the communications transceiver of the mobile platform and the communication channel manager.

The broadcast transmitter(s) 15, 15′ use known broadband broadcasting mechanisms and techniques, including those which communicate in accordance with, e.g., ATSC or other standards. The ATSC standards define digital television which has been selected by the United States Federal Communications Commission (‘FCC’) for terrestrial television station broadcasting, e.g., for HDTV. Broadband refers to a communication signal comprising a wide range of frequencies, permitting simultaneous transmission of multiple pieces of data, increasing data transmission rates. Thus, multiple channels are communicated using the same communications medium through a process referred to as multiplexing. The FCC-approved ATSC standard has a data throughput of 19.38 Mbps, whereas HDTV utilizes only 9 to 12 Mbps. This means that there is communications throughput available for the delivery of additional content which may be utilized. It is this portion of the broadcast signal which is preferably used to communicate the first message to the mobile platform(s) 30, 30′.

With additional reference now to FIGS. 3 and 4, the enterprise services provider 240 and the mobile platforms 30, 30′ execute two-way communications, including receiving authenticated inputs and requests from the operator and/or passenger(s) of the mobile platform, via a human/machine interface (EMI) device(s) 350 at the mobile platform. The inputs and requests included in the information are communicated to the local content manager. The enterprise services provider 240 generates the first message for the broadcast signal, and facilitates acquiring content for the first message for the broadcast signal from one of the other content providers 210, 220, 230. Facilitating acquiring content includes the user of the mobile platform identifying specific information by way of the HMI, including using a menu-driven or other system for inclusion in the second message, which is formed and communicated to the enterprise services provider 240 using the two-way communications. The enterprise services provider 240 interacts with the content providers 210, 220, 230 to identify a source for the specific information, which then acquires it and provides it for inclusion in the first message.

The two-way communications link enhances the robustness of a security management system, including authentication, provisioning, and digital rights management. Thus, the wireless two-way message may be used to authenticate the broadcast signal, including the first message. It may also aid in the delivery of missing data either by allowing the mobile platform to request retransmission of data via the broadcast signal 25 or by delivering the missing data directly via the two-way wireless message 35, 35′.

An encoded directory structure residing on a remote server as a string may be periodically transmitted uni-directionally, i.e., via broadcast signals, to the mobile platform for consumption. The mobile platform can pick up and choose content from the directory structure to display. The directory structure may be populated with a mixture of dynamic and static content collected from the Internet and private sources. Furthermore, the content may be delivered to multiple locations within the vehicle, e.g., front and back seat vehicle screens either in real-time or stored for consumption at a later time. Such delivery processes include delivering packets of information that are acknowledged as received via the two-way wireless message 35. The uplink can facilitate monitoring of exposure to advertising, and report application or service usage for billing and other purposes.

The first message of the broadcast signal 25, in the form of electronic data, is opportunistically transmitted, and received and cached in each mobile platform during periods of availability of bandwidth and/or the availability of the communication channel through the communication source 10 and transmitter(s) 15, 15′.

Delivery of the first message to the mobile platform requires a communication transmission channel and a minimum bandwidth determined by well-known theorems such as Shannon Theorem, the operation of which is provided at the communications source 10. In cases where exact real time delivery is not required, bandwidth requirement can be distributed in various dimensions such as time, and spreading codes and/or frequencies. Various sections of the electronic data making up the first message may be scattered by the communications manager 14 in these various dimensions and then re-assembled at the communications transceiver of the mobile platform(s) 30, 30′. The communications source 10 opportunistically assigns the delivery mechanisms, comprising throughput, time, frequency, and other parameters of the broadcasting and communication system, based upon availability. The communications manager 14 coordinates the distribution of the first message through the broadcast transmitter(s) 15, 15,.

The mobile platform 30 taking the form of a handheld device is now described, preferably equipped with the WID 310, a transceiver coordinator 320, an application processor 330, an electronic storage manager 315, a knowledge control center 360, at least one HMI device 350 (which communicates via an interface controller 340), and a software update coordinator and an enterprise service manager 325.

The WID 310 preferably comprises at least one transmitter and receiver which interact with the transceiver coordinator 320 to receive the broadcast signal 25 and interpret the first message therefrom. The WID also comprises a modulator device operative to transmit signals wirelessly to effect two-way communications. The WID 310 utilizes cellular or other technologies incorporated into the transceiver coordinator 320 to effect communications with the communication source 10. The WID 310 receives the broadcast signal 25 including the first message from the communication source 10, and transmits the second message via the two-way wireless message 35 to the communication source 10.

The storage manager 315 preferably comprises removable/portable storage media, e.g., DVDs, CDs, and thumbstick memory devices, and, embedded storage media in the form of hard-drive or chip memory devices. The WID 310 is operative to receive the broadcast signal 25, identify the first message and selectively route it to the storage manager 315 for caching and future use, or to the application processor 330 for immediate use.

The knowledge control center 360 preferably comprises an updatable electronic memory portion which contains states determined for a plurality of characteristics or parameters of the mobile platform. The application processor 330 interacts with the knowledge control center 360 to capture and generate information related to the specific mobile platform, as may be obtained by monitoring and observing via sensors the environment or the interactions of the user with the mobile platform through the HMI 350. The parameters of the mobile platform may include current location and the recent mobile platform trajectory when the mobile platform is equipped with a GPS (‘global positioning system’) device or is otherwise capable of determining geographic position.

The knowledge control center 360 preferably includes a selective profile of the end user that is compiled on-board or off-board. The user profile preferably includes personal preferences, purchasing histories, previous platform trajectories, user/platform interactions and learning therefrom, user demographics, and other information useful to and selectable by the end-user. The user profile may be used by the mobile platform 30 to selectively access the first message of the broadcast signal and to selectively use the information in any interaction with the user. Software updates, new applications, and other data updates are selectively downloaded into the mobile platform 30. Interactions with the user, including the selective display of advertisements, may be governed by the user profile. The software update coordinator/enterprise service manager 325 provides functionality to update operating software of the mobile platform 30, and manage information related to the enterprise for which the mobile platform is utilized.

The HMI 350 may include touch or stylus-sensitive displays, alpha-numeric keypads, scrolling devices and other devices. Additional HMI functionality is envisioned wherein handheld devices on the mobile platform 30 are interfaced with a docking structure on a vehicle through which enhanced input/output control may be achieved. Through such HMI, the operator is able to interact with the device to receive and communicate the content of the first message, as managed through the interface controller 340. The modality of the content of the first message delivered to the HMI(s) may be in the form of user-interpretable text, images, videos, and/or sounds or output signals. The modality is adjustable based on mobile platform dynamics and the expected consumer of the content of the first message, i.e., a user holding the mobile platform 30. The user includes an individual holding the handheld device 30. The user includes the operator or passenger interacting with an on-vehicle device as the mobile platform 30′.

The application processor 330 comprises an element of the operating system for the mobile platform 30 which calls specific programs and systems in the receiver into action and manages interactions. This includes capturing selected portions of the broadcast signal 25 which comprise the first message, routing the first message to the storage manager for storage, routing the first message to the HMI device, routing software updates from the software update coordinator 325 to the storage manager 315, routing information from the knowledge center 360 and other locations for transmission by the WID 310 to the communication source 10, and performing other information processing operations. The application processor 330 includes information management functionality, responsible for the storage and manipulation of information. It includes a collection of related functions, consisting of: managing mass data storage through the storage manager 315; maintaining security (e.g., authentication and digital rights management); audio, video, and information content storage and queuing; audio, video, and information content manipulation; and, HMI control.

In many cases, the content of the first message may have a limited life, and expire, or become outdated, at different time intervals. The application processor interacts with the communication source 10 by sending the second message thereto via the two-way wireless message 35 to selectively request refresh, or update of the content of the first message when expiration approaches or when new or replacement content is made available from the communication source 10. Such updates may alternatively be updated without such requests also. Thus the content of the first message may be formed based upon the second message. An example of such content is a collection of local vendors of goods and services. Some content, like availability of goods and services, prices, specials, location and contact information for an individual or some subset collection of vendor information can be updated independently of each other. Other content from services, such as news and weather, may be time-sensitive and may be programmed to expire automatically after a certain time period, or expire at a specific date and time.

The software update coordinator/enterprise service manager 325 operate to control the flow and use of information sent to the mobile platform, including collecting and transmitting information available to the mobile platform to the communications source 10 in the second message. The software update coordinator function comprises coordinating the distribution and updating of programming information, specifically executable code that is used on the mobile platform itself or by another device in proximity to the mobile platform. The programming information may be utilized by programmable devices, including central processing units, digital signal processing units, and other devices. The enterprise service management function includes managing enterprise services, such as services supplied to the user of the mobile platform. It also includes selection and display of advertising content. The enterprise service management function further includes generating the second message by gathering information originating at the mobile platform, and guaranteeing system integrity by performing functions such as provisioning (validating entitlement to services), authentication (validating legitimacy of broadcaster and mobile platform), and privacy management (through encryption and decryption and various ancillary functions).

The mobile platform 30′ takes the form of an on-vehicle device. The mobile platform 30′ has many of the same features and functions as the previously described handheld 30, preferably with added functionality related to multiple users and related to application on a motor vehicle. Substantially similar functionality and apparatus are illustrated using the same reference numerals in FIG. 4 as were used in FIG. 3.

The transceiver, information management system, and various human-machine interfaces (HMI) are operative to communicate therebetween, and with on-vehicle data-buses to other vehicle systems, as shown. The mobile platform may include multiple HMI devices 350, 350′, 350″, each of which communicates via the interface controller 340′. The vehicle software update coordinator 325′ is signally connected to a vehicle databus 370, which is in signal communication with one or more on-vehicle control modules operative to control one or more vehicle systems. Through this connection, the software update coordinator 325′ is operative to communicate a portion of the first message comprising updated executable code for vehicle operation to the appropriate vehicle control module. The knowledge control center 360′ is adapted to determine states for a plurality of characteristics or parameters of the mobile platform 30′, for example, vehicle operating parameters, settings, dynamics, and position when equipped with a GPS system or otherwise capable of determining geographic position. The knowledge control center 360′ preferably includes selective profiles of one or more end users including vehicle operators and passengers that are compiled on-board or off-board. The knowledge control center 360′ is signally connected to the vehicle bus 370 to obtain access to information associated with the vehicle operating parameters. User profiles corresponding to mobile platform 30′ are generally similar to those described with regard to the handheld mobile platform 30.

In operation, each of the mobile platforms within range of the communication source 10 receives and interprets the broadcast signal 25 to obtain the first message. The mobile platform is operative to present the first message to the user in various modalities, or forms. Using vehicle attributes such as vehicle dynamics, vehicle type, vehicle usage profile, and demographics, a scheme is developed to provide an opportunistic delivery receipt and caching of the content of the first message. In some vehicular systems it may be advantageous to update, modify, and refresh the message content while the vehicle is stationary, or nearly stationary. Furthermore, refreshing the message content may be better suited to periods of opportunistic availability of the communication channel bandwidth, such as when the bandwidth is shared with other users and applications. Further, user interactions may be modified based upon various factors including vehicle dynamics, vehicle type, vehicle usage profile, demographics, passengers, and operator skills. Furthermore, refreshing the message content may be better suited to periods of opportunistic availability of the mobile platform 30′, which may be unable to receive the broadcast signal 25 because the mobile platform 30′ is not powered, or the condition of the broadcast signal is poor, or other reasons.

During message content presentation, the modality of the content is in the form of end-user interpretable text, images, videos, and/or sounds or signal output. The modality may be adjusted based on vehicle dynamics and the intended consumer of the information. For example, video content display and interaction with the vehicle operator are preferably disabled during vehicle motion, or limited in modality to only audio or non-interactive aspects of map guidance. When the vehicle stops, or slows to a low speed, the disabled video and interactive components may be reactivated. Furthermore the operator may personally control the specific modality to their preferences, for example, by stopping, or pausing, all playback of the content, including audio, until the vehicle stops or slows to low speed. For a passenger, the video and audio is not affected by the vehicle speed. However, a passenger may be able to control functions, such as stopping, pausing, reversing, or forwarding playback of content.

The content of the first message at the EMI may include formatted screen displays that are populated with current information. For example, a default screen can include dedicated size and position of a traffic map, a weather map and/or forecast, and advertisement content. The advertisement content may be linked, via the vehicle bus, to a telematics unit, through a simple user interface, operative to initiate a phone call or an interactive request for additional information. The advertisement content may be used to generate revenue that funds all, or part of, the operation of the content delivery system,

Other mobile platforms which may incorporate the system described herein include personal digital assistants (PDAs), cellular phones, personal entertainment devices, navigation/GPS devices, and integrated combinations thereof, including such devices which are adapted for handheld use as well as transportable among various docking systems including docking with a vehicle.

The disclosure describes the system operative for reception of the map image for use with, for example, a graphical touch-screen display device having a known resolution and dimension, i.e., the HMI 350. The content of the first message delivered to the mobile platform via a broadcast signal comprises map images and map-related information for a predetermined region. The map image includes a scaled diagrammatic image of a geographic surface defined in terms of conventional Cartesian coordinates and depicting locations of cities, towns, political boundaries, streets, roads, and geographic features. An overlay image includes a diagrammatic image applicable to a specific segment of the map image which depicts locations of identifiable points of interest on the specific segment of the map image. The points of interest may include, e.g., services such as fuel stations, restaurants, rest stops, Post Offices, and shopping centers; attractions such as zoos, historical sites, and, playgrounds; and time-sensitive information such as weather and traffic conditions.

The communications source broadcasts the content of the first message, in the form of computer-readable data, which is read by each of the mobile platforms 30, 30′. The data of the first message comprises map images and overlay images. The map image and overlay images have been structured, organized, and parsed into a plurality of predefined map picture tiles and overlay picture tiles, respectively, and captured and stored in a plurality of electronic data files. Each map picture tile comprises an image of a predefined segment of the map image. The predefined segment of the map image for a geographic area is preferably a rectangular area, specifically defined by four corner points consisting of coordinates of latitude and longitude, which correspond to corner pixels of the map picture tile associated therewith. The coordinates of latitude and longitude which correspond to corner pixels of each map picture tile of the map image are captured therewith, for purposes of identifying the map picture tile. Each map picture tile is captured and converted to electronic data using one or more known formats, such as those utilized on internet applications. Electronic data files comprising graphical images illustrative of the concept include those comprising bitmapped image formats generated in compressed data formats having computer file extensions such as gif, jpeg, jpe, jfif and jif, which are decoded using known computer and html applications. The images are stored in electronic memory by the storage manager 315 and are viewed on the HMI 350 display screen using a device application. The device application determines the image from memory to be displayed based on an operator request or other device information (e.g., GPS position and direction, date, time, and velocity). The device application and associated graphics display hardware render the map image from memory viewable on the HMI display screen. Overlay images containing map-related information are similarly generated. Data files for each map picture tile include the coordinates or other numbering hierarchy to identify the location of the image relative to other images stored in memory, and preferably provide a location identifiable to a coordinate system for a GPS device. These coordinates are preferably defined by latitude and longitude coordinates at corresponding corner pixels of each of the map picture tiles, wherein the center pixel or other pixels within the image comprise a numerical value identifying the image. Additionally, the map picture tiles and overlay picture tiles may include date, time, duration, and priority stamps that allow the device application to determine how to act upon each tile. For example, if a temporary but urgent weather or other travel related incident occurs in an area in the vicinity of a broadcast tower, a temporal map picture tile or overlay picture tile indicating appropriate instructions, routes, or other pertinent information may be transmitted with a high priority and have an appropriate duration of time. The device application may then temporarily replace an existing tile in memory with the new one, after which time the temporal map and overlay picture tiles are discarded by the application.

Each mobile platform comprises an on-board application device in the HMI that has minimal processing capability. The first message is calculated and formatted remotely at the communications source 10 to conform to the device application and the HMI 350, as previously described. The content of the first message preferably comprises current information, including the map image and overlay images of map-related data comprising a traffic map image, a weather map image, and/or forecast, and advertisement content. The advertisement content is preferably linked, via the vehicle bus, to a telematics unit, through a simple user interface, operative to initiate a phone call or an interactive request for additional information The advertisement content may be used to generate revenue that funds all, or part of, the operation of the content delivery system.

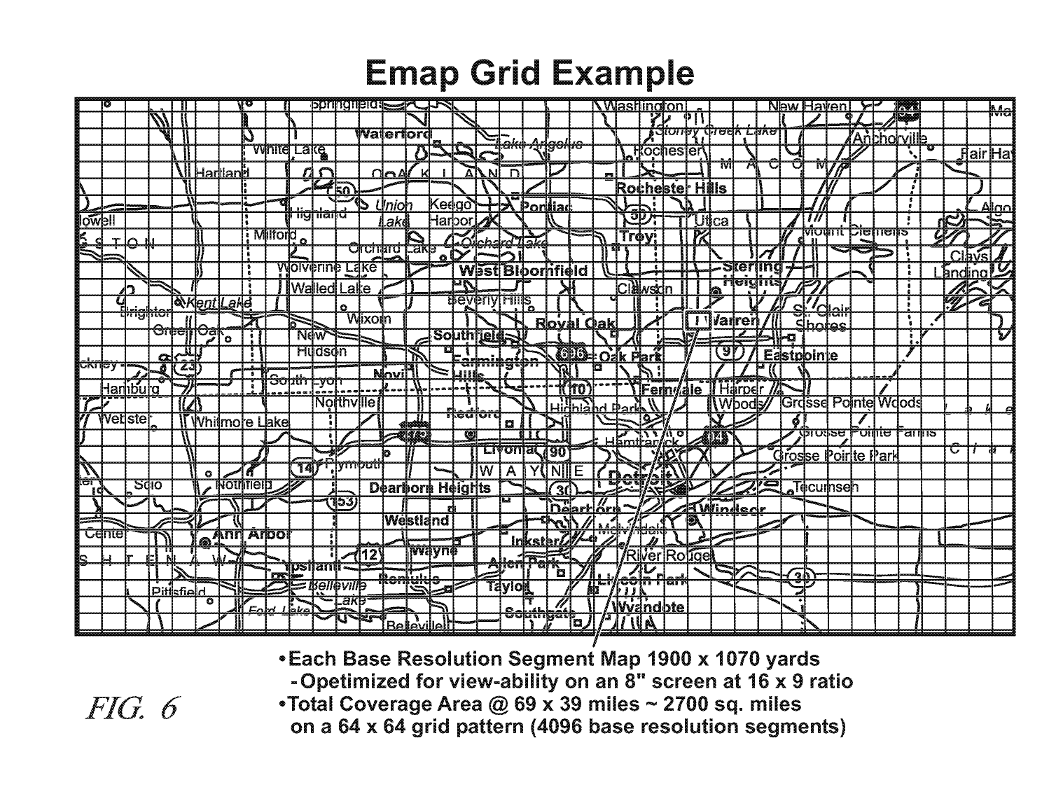

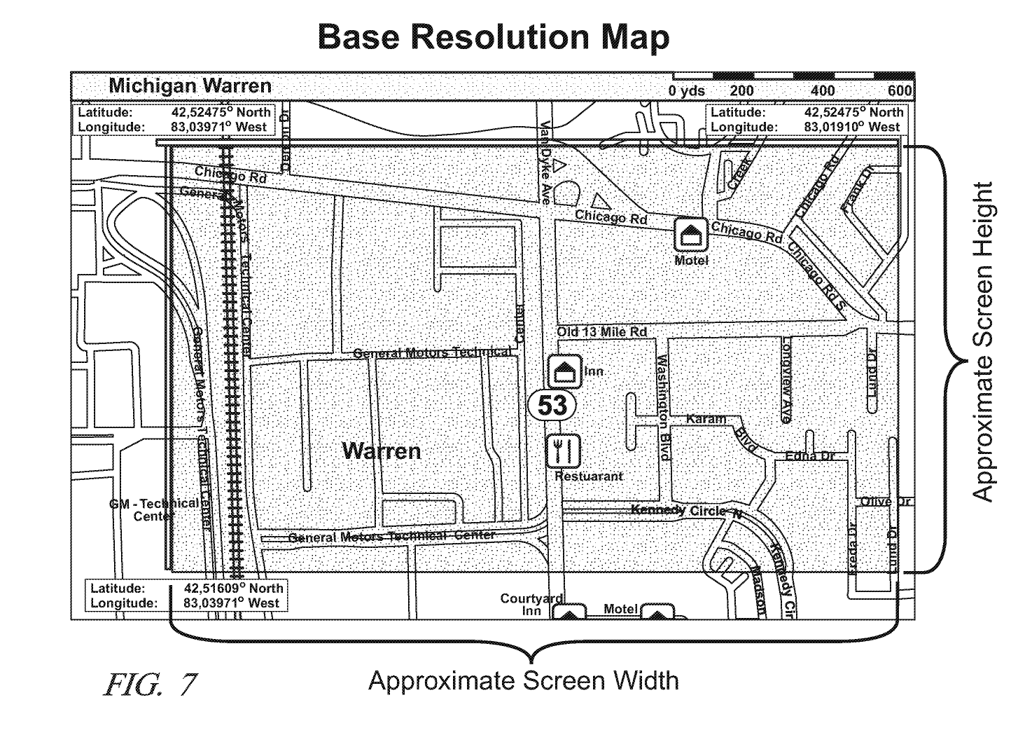

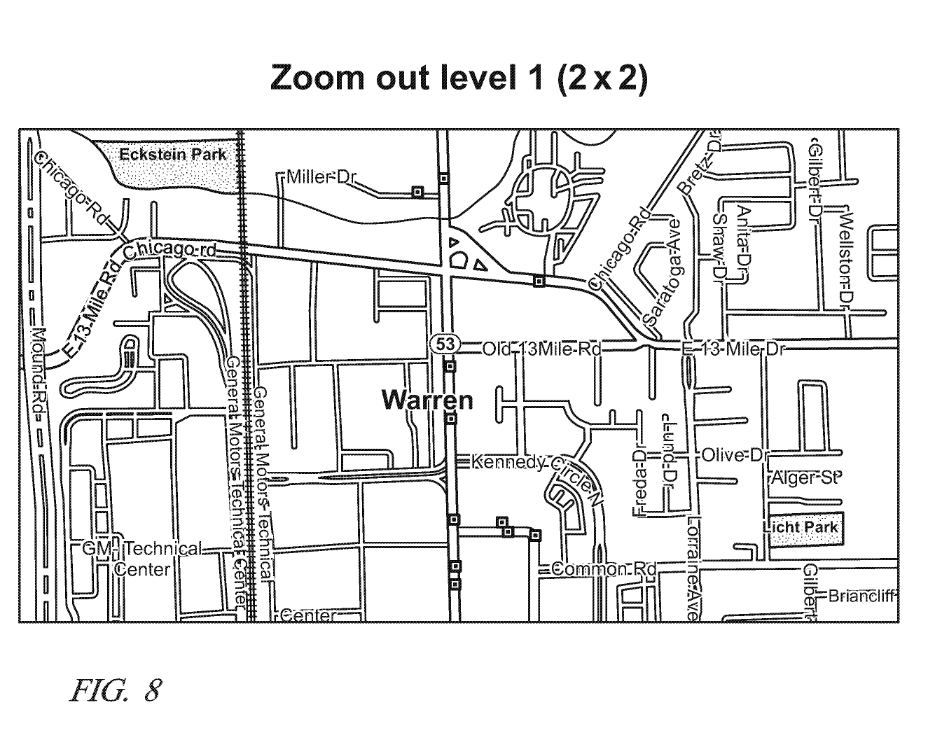

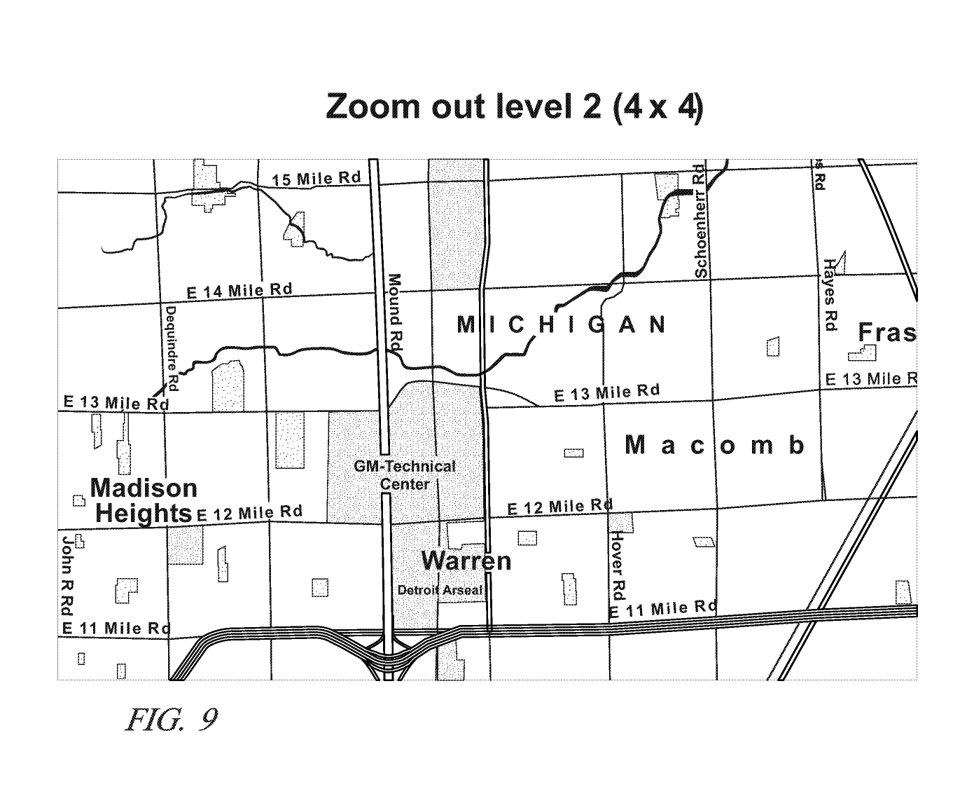

Referring now to FIGS. 5-9, graphical depictions illustrative of the disclosure are provided for the exemplary embodiments described herein, with regard to a system designed for vehicular reception of map image data for use with the FMI display device having a known resolution and dimension. General delivery of the map images and the overlay images of map-related information for a predefined region is accomplished by broadcasting pictorial representations of all the map and overlay picture tiles in that region in sufficient detail and layers to allow viewing from street level to freeway level. A region comprises the area immediately surrounding the broadcast transmitter, and may include entire countries. Updated map images are transmitted at regular intervals and replace the resident map and overlay picture tiles in the device memory. FIG. 5 depicts a pictorial representation of a specific map image for a region comprising southeastern Michigan which is transmitted to the platform and displayed thereat, having an overall dimension of about 110 km×60 km. FIG. 6 depicts a pictorial representation of the specific map image with an applied grid, wherein each grid segment, represented by a map picture tile, has dimensions of about 1740 meters×980 meters. FIG. 7 depicts the specific map area for a single map picture tile; FIG. 8 depicts a first zoom-out depicting two-by-two, or four map picture tiles, and FIG. 9 depicts a second zoom-out depicting four-by-four, or sixteen, map picture tiles.

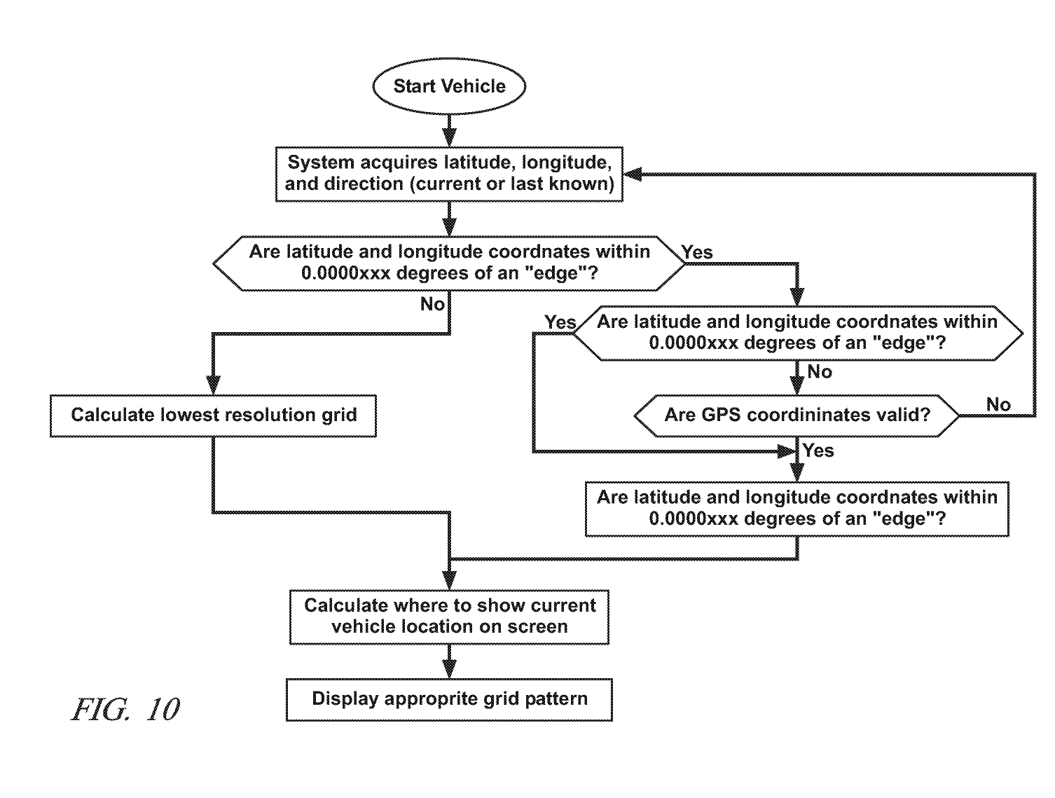

Referring now to FIG. 10, functionality of the system is preferably enhanced by use of a global position sensing (GPS) receiver at the mobile platform 30, 30′ to determine the specific map picture tile, i.e., base resolution tile of the map image, to display when mapping function is activated. This comprises determining latitudinal and longitudinal coordinates of the mobile platform 30, 30′, and a direction of travel thereof. A lowest resolution grid or segment is determined, and location of the device is depicted on the displayed map picture tile on the display screen of the HMI 350. The HMI determines which map picture tile to display by comparing the communication receiver latitudinal and longitudinal coordinates of the mobile platform and the specific map picture tile which coincides therewith, i.e., the map picture tile within which the mobile platform lies, based upon the coordinates of the map picture tile in memory. Location of the mobile platform on the map image is determined by the device application by comparing latitudinal and longitudinal coordinates of the mobile platform with those latitudinal and longitudinal coordinates of the images stored in memory and calculating relative position on the screen. When the mobile platform approaches a boundary of a specific map picture tile leading to an adjacent picture tile, the latitudinal and longitudinal coordinates are verified, and the direction and the location of the mobile platform is depicted on the screen on the displayed tile, preferably at the second lowest resolution, i.e., the two-by-two grid depicted in FIG. 8.

In an enhancement of system functionality, a user-specified route is calculated using a remote display device that generates the desired route depicted as a picture, pictures, or text. The depiction of the desired route is formatted for the display screen and delivered to the vehicle via either a wired or wireless communication. Wireless transmission of the route depiction is preferably accomplished as defined hereinabove, using existing methods to define the individual mobile platform that is scheduled to receive the route. Transmitted along with the route depiction, or through remote scheduling, there is a time-stamp to allow the route depiction to be deleted after an elapsed period of time, either by the communications receiver or the communications source.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. Method for communicating a graphic image to a mobile platform, comprising:
equipping the mobile platform with a broadcast signal receiver device to receive a broadcast message, an electronic memory storage device, a processor, and a human-machine interface comprising a visual display screen;
receiving a first message broadcast from the communications source within a broadcast signal at the mobile platform via the broadcast signal receiver device, the first message comprising the graphic image;
caching the graphic image in the electronic memory storage device; and,
selectively displaying the graphic image with the visual display screen of the human-machine interface.

2. The method of claim 1, wherein the graphic image comprises a preformatted electronic data file comprising a map image of a predetermined geographic area.

3. The method of claim 2, wherein the graphic image further comprises a preformatted electronic data file comprising an overlay image of the predetermined geographic area.

4. The method of claim 2, wherein the preformatted electronic data file comprising the map image comprises a bitmap image data file.

5. The method of claim 2, wherein the map image of the predetermined geographic area comprises a scaled diagrammatic image of the geographic area with boundaries defined using Cartesian coordinates.

6. The method of claim 5, wherein the map image depicts a location of at least one of cities, towns, political boundaries, streets, roads, and geographic features.

7. The method of claim 3, wherein the overlay image of the predetermined geographic area comprises a diagrammatic image applicable to the map image of the predetermined geographical area depicting locations of points of interest.

8. The method of claim 2, wherein the preformatted electronic data file comprising the map image of the predetermined geographic area further comprises the map image parsed into a plurality of predefined map picture tiles each comprising an image of a predefined segment of the map image.

9. The method of claim 8, further comprising displaying one of the predefined map picture tiles at the visual display screen of the human-machine interface.

10. The method of claim 9, further comprising displaying one of the predefined map picture tiles at the visual display screen of the human-machine interface in response to an operator input.

11. Method for transferring an image to a mobile platform, comprising:
equipping the mobile platform with a wireless interface device operative to receive broadcast signals and execute two-way wireless communications, an electronic memory storage device, a processor, and, a human-machine interface comprising a visual display screen;
opportunistically receiving a broadcast signal comprising a first message at the mobile platform via the wireless interface device wherein the first message comprises an image of a predetermined geographic area;
caching the first message in the electronic memory storage device; and,
selectively displaying a segment of the first message with the visual display screen of the human-machine interface.

12. The method of claim 11, further comprising opportunistically incorporating the first message into a high-throughput digital broadcast signal from a communications source.

13. The method of claim 12, further comprising opportunistically incorporating the first message during a period of available bandwidth into the high-throughput digital broadcast signal.

14. The method of claim 13, wherein the image comprises a bitmap image data file of a map of the predetermined geographic area.

15. The method of claim 14, wherein the image comprises a bitmap image data file of an overlay image of the map of the predetermined geographic area depicting locations of points of interest.

16. The method of claim 11, further comprising:
parsing the image of the predetermined geographic area into a plurality of predefined picture tiles each comprising an image of a predefined segment of the image of the predetermined geographic area; and
generating bitmap image data files of the predefined picture tiles.

17. The method of claim 16, further comprising:
equipping the mobile platform with a global positioning system operative to identify a geographic position of the mobile platform; and,
selectively displaying one of the predefined picture tiles coincident with the identified geographic position of the mobile platform.

18. The method of claim 12, wherein opportunistically receiving the broadcast signal comprising the first message at the mobile platform via the wireless interface device comprises opportunistically receiving the broadcast signal based upon availability of the mobile platform.
